(19) United States
(12) Patent Application Publication
(10) Pub. No.: US 2026/0301304 A1
(43) Pub. Date: Oct. 1, 2026

(54) SYSTEMS AND METHODS FOR GENERATING AND USING PRIMARY RAY-BASED IMPLICIT NEURAL REPRESENTATIONS OF THREE-DIMENSIONAL OBJECTS

(71) Applicant: Google LLC, Mountain View, CA (US)

(72) Inventors: Yushan Feng, San Francisco, CA (US); Ruofei Du, San Francisco, CA (US); Yinda Zhang, Daly City, CA (US); Danhang Tang, West Hollywood, CA (US)

(21) Appl. No.: 18/881,348

(22) PCT Filed: Jul. 20, 2022
(86) PCT No.: PCT/US2022/037697

§ 371 Date: Jan. 6, 2025

(51) Int. Cl. G06T 15/06; G06V 10/82

(52) U.S. Cl. CPC G06T 15/06; G06V 10/82

(57) ABSTRACT

Systems and methods for generating and using primary-ray based implicit neural representations of three-dimensional objects. In some examples, an implicit neural representation of an object may be generated by training a neural network using training examples that include a reference point, a ray, a perpendicular foot of the ray relative to the reference point, and a distance indicator indicating the shortest distance along the ray between the perpendicular foot and a surface of the object, and, optionally, an intersection indicator indicating whether the ray will intersect with the object. Once trained, the neural network may then be used to generate predictions of whether a ray will intersect with the object, and/or predictions of the shortest distance along a ray between its perpendicular foot and a surface of an object, based on a given reference point, ray, and perpendicular foot of the ray relative to the reference point.

### BACKGROUND

Generating an accurate and efficient representation of a three-dimensional object's geometry is an important problem for computer graphics, computer vision, and robotics. Recent advances in machine learning have inspired a growing trend of implicit neural shape representations, where a neural network is trained to predict some value or function that may be used to determine, for a given location in 3D space, the location of a nearest surface on an object. However, many such implicit neural representations are trained to predict values or functions (e.g., the signed distance function (“SDF”) between a given point and the nearest surface of the object) that require compute-intensive further processes in order to derive a given hit point on the surface of the object. This can thus complicate many tasks that an implicit neural representation may be used for (e.g., shape rendering or extraction, shape completion, camera pose estimation, etc.), making them more compute-intensive and/or less accurate than they might otherwise be if the implicit neural representation were instead trained to directly predict points on the surface of an object.

### BRIEF SUMMARY

The present technology concerns systems and methods for generating and using primary-ray based implicit neural representations of three-dimensional objects. For example, in some aspects of the technology, an implicit neural representation of an object may be generated by training a neural network using training examples that include a reference point, a ray, a perpendicular foot of the ray relative to the reference point, a distance indicator indicating the ground truth of the shortest distance along the ray between the perpendicular foot and a surface of the object, and, optionally, an intersection indicator indicating the ground truth of whether the ray will intersect with the object. The neural network may then be trained to generate one or more predictions based on the provided reference point, ray, and perpendicular foot of the ray relative to the reference point, such as an intersection prediction representing its prediction of whether the ray will intersect with the object, and/or a distance prediction representing its prediction of the shortest distance along the ray between its perpendicular foot and a surface of an object. The intersection prediction may then be compared to the intersection indicator to generate an intersection loss value, and the distance prediction may be compared to the distance indicator to generate a distance loss value. The resulting loss values may then be used (by themselves, or as a part of an aggregate loss value) to modify one or more parameters of the neural network. By training a neural network in this way with a suitable set of training examples for a given object, it may become an implicit neural representation of the object, capable of accurately predicting, for a given ray and its perpendicular foot (relative to a given reference point), the distance along the ray between the perpendicular foot and the nearest surface of the object.

Advantageously, implicit neural representations generated according to the present technology do not require compute-intensive sphere-tracing or Marching Cubes processes in order to generate a rendering or polygon mesh of an object, leading to substantial efficiencies over (e.g., reducing compute time by more than half when compared to) implicit neural representations that are trained to predict the SDF for a given point in space. In addition, implicit neural representations generated according to the present technology are not limited to watertight shapes, as with many implicit neural representations trained to predict SDF. Accordingly, the present technology may be used to generate implicit neural representations which may be several times smaller, or even orders of magnitude smaller, than a traditional three-dimensional model of a given object, and yet which may enable accurate and efficient on-the-fly renderings of the object from any angle. Likewise, the present technology may improve accuracy over SDF-based approaches for a variety of other generative tasks, such as completing a shape from noisy or incomplete input data, or estimating a camera pose from a given silhouette image of an object. Accordingly, the present technology may be advantageous in any application where speed, accuracy, and/or model size are of importance, such as in shape rendering or extraction, shape completion, camera pose estimation, scanning and reconstruction of 3D objects (e.g., as may be performed in machine vision and augmented reality applications), streaming of 3D shapes (e.g., as may be performed for video games, augmented reality applications, or presenting interactive 3D models of objects on an online shopping site), etc.

In one aspect, the disclosure describes a computer-implemented method of generating an implicit neural representation of an object, comprising: (1) for each given training example of a plurality of training examples, the given training example including a reference point, a ray, a perpendicular foot of the ray relative to the reference point, an intersection indicator indicating whether the ray will intersect with the object, and a distance indicator indicating a shortest distance along the ray between the perpendicular foot and a surface of the object: generating, using a neural network, an intersection prediction based on the reference point, the ray, and the perpendicular foot of the ray relative to the reference point, wherein the intersection prediction represents a prediction of whether the ray will intersect with the object; generating, using the neural network, a distance prediction based on the reference point, the ray, and the perpendicular foot of the ray relative to the reference point, wherein the distance prediction represents a prediction of the shortest distance along the ray between the perpendicular foot and a surface of the object; comparing, using one or more processors of a processing system, the intersection indicator to the intersection prediction to generate an intersection loss value for the given training example; and generating, using the one or more processors, a distance loss value for the given training example based at least in part on a comparison of the distance indicator to the distance prediction; and (2) modifying, using the one or more processors, one or more parameters of the neural network based at least in part on the intersection loss values and the distance loss values generated for the plurality of training examples. In some aspects, for each given training example of the plurality of training examples, the ray is represented as a ray origin and a ray direction. In some aspects, the ray origin is the perpendicular foot of the ray relative to the reference point. In some aspects, the ray origin is a point different than the perpendicular foot of the ray relative to the reference point. In some aspects, the neural network is a multilayer perceptron.

In another aspect, the disclosure describes a computer program product comprising computer readable instructions that, when executed by a processing system, cause the processing system to perform any of the methods described in the preceding paragraph.

In another aspect, the disclosure describes a processing system comprising: (1) a memory storing a neural network; and (2) one or more processors coupled to the memory and configured to generate an implicit neural representation of an object according to a method comprising: (a) for each given training example of a plurality of training examples, the given training example including a reference point, a ray, a perpendicular foot of the ray relative to the reference point, an intersection indicator indicating whether the ray will intersect with the object, and a distance indicator indicating a shortest distance along the ray between the perpendicular foot and a surface of the object: generating, using a neural network, an intersection prediction based on the reference point, the ray, and the perpendicular foot of the ray relative to the reference point, wherein the intersection prediction represents a prediction of whether the ray will intersect with the object; generating, using the neural network, a distance prediction based on the reference point, the ray, and the perpendicular foot of the ray relative to the reference point, wherein the distance prediction represents a prediction of the shortest distance along the ray between the perpendicular foot and a surface of the object; comparing, using one or more processors of a processing system, the intersection indicator to the intersection prediction to generate an intersection loss value for the given training example; and generating, using the one or more processors, a distance loss value for the given training example based at least in part on a comparison of the distance indicator to the distance prediction; and (b) modifying, using the one or more processors, one or more parameters of the neural network based at least in part on the intersection loss values and the distance loss values generated for the plurality of training examples. In some aspects, the one or more processors are configured to generate the implicit neural representation of the object according to the method where, for each given training example of the plurality of training examples, the ray is represented as a ray origin and a ray direction. In some aspects, the one or more processors are configured to generate the implicit neural representation of the object according to the method where, for each given training example of the plurality of training examples, the ray origin is the perpendicular foot of the ray relative to the reference point. In some aspects, the one or more processors are configured to generate the implicit neural representation of the object according to the method where, for each given training example of the plurality of training examples, the ray origin is a point different than the perpendicular foot of the ray relative to the reference point. In some aspects, the neural network is a multilayer perceptron.

In one aspect, the disclosure describes a computer-implemented method of generating an implicit neural representation of an object, comprising: (1) for each given training example of a plurality of training examples, the given training example including a reference point, a ray, an intersection indicator indicating whether the ray will intersect with the object, and a distance indicator indicating a shortest distance along the ray between a perpendicular foot of the ray relative to the reference point and a surface of the object: determining, using a neural network, the perpendicular foot of the ray relative to the reference point; generating, using the neural network, an intersection prediction based on the reference point, the ray, and the perpendicular foot of the ray relative to the reference point, wherein the intersection prediction represents a prediction of whether the ray will intersect with the object; generating, using the neural network, a distance prediction based on the reference point, the ray, and the perpendicular foot of the ray relative to the reference point, wherein the distance prediction represents a prediction of the shortest distance along the ray between the perpendicular foot and a surface of the object; comparing, using one or more processors of a processing system, the intersection indicator to the intersection prediction to generate an intersection loss value for the given training example; and generating, using the one or more processors, a distance loss value for the given training example based at least in part on a comparison of the distance indicator to the distance prediction; and (2) modifying, using the one or more processors, one or more parameters of the neural network based at least in part on the intersection loss values and the distance loss values generated for the plurality of training examples. In some aspects, for each given training example of the plurality of training examples, the ray is represented as a ray origin and a ray direction. In some aspects, for each given training example of the plurality of training examples, the neural network determines the perpendicular foot of the ray relative to the reference point based on the ray origin and the ray direction of the given training example. In some aspects, the ray origin is a point different than the perpendicular foot of the ray relative to the reference point. In some aspects, the neural network is a multilayer perceptron.

In another aspect, the disclosure describes a computer program product comprising computer readable instructions that, when executed by a processing system, cause the processing system to perform any of the methods described in the preceding paragraph.

In another aspect, the disclosure describes a processing system comprising: (1) a memory storing a neural network; and (2) one or more processors coupled to the memory and configured to generate an implicit neural representation of an object according to a method comprising: (a) for each given training example of a plurality of training examples, the given training example including a reference point, a ray, an intersection indicator indicating whether the ray will intersect with the object, and a distance indicator indicating a shortest distance along the ray between a perpendicular foot of the ray relative to the reference point and a surface of the object: determining, using a neural network, the perpendicular foot of the ray relative to the reference point; generating, using the neural network, an intersection prediction based on the reference point, the ray, and the perpendicular foot of the ray relative to the reference point, wherein the intersection prediction represents a prediction of whether the ray will intersect with the object; generating, using the neural network, a distance prediction based on the reference point, the ray, and the perpendicular foot of the ray relative to the reference point, wherein the distance prediction represents a prediction of the shortest distance along the ray between the perpendicular foot and a surface of the object; comparing, using one or more processors of a processing system, the intersection indicator to the intersection prediction to generate an intersection loss value for the given training example; and generating, using the one or more processors, a distance loss value for the given training example based at least in part on a comparison of the distance indicator to the distance prediction; and (b) modifying, using the one or more processors, one or more parameters of the neural network based at least in part on the intersection loss values and the distance loss values generated for the plurality of training examples. In some aspects, the one or more processors are configured to generate the implicit neural representation of the object according to the method where, for each given training example of the plurality of training examples, the ray is represented as a ray origin and a ray direction. In some aspects, for each given training example of the plurality of training examples, the neural network is configured to determine the perpendicular foot of the ray relative to the reference point based on the ray origin and the ray direction of the given training example. In some aspects, the one or more processors are configured to generate the implicit neural representation of the object according to the method where, for each given training example of the plurality of training examples, the ray origin is a point different than the perpendicular foot of the ray relative to the reference point. In some aspects, the neural network is a multilayer perceptron.

In another aspect, the disclosure describes a computer-implemented method of using a neural network representing an implicit neural representation of an object, comprising: generating, using the neural network, an intersection prediction based on a reference point, a ray, and a perpendicular foot of the ray relative to the reference point, wherein the intersection prediction represents a prediction of whether the ray will intersect with the object; and generating, using the neural network, a distance prediction based on the reference point, the ray, and the perpendicular foot of the ray relative to the reference point, wherein the distance prediction represents a prediction of a shortest distance along the ray between the perpendicular foot and a surface of the object. In some aspects, the ray is represented as a ray origin and a ray direction. In some aspects, the ray origin is the perpendicular foot of the ray relative to the reference point. In some aspects, the ray origin is a point different than the perpendicular foot of the ray relative to the reference point. In some aspects, the method further comprises: determining, using the neural network, the perpendicular foot of the ray relative to the reference point. In some aspects, the neural network is configured to determine the perpendicular foot of the ray relative to the reference point based on the ray origin and the ray direction. In some aspects, the neural network is a multilayer perceptron.

In another aspect, the disclosure describes a computer program product comprising computer readable instructions that, when executed by a processing system, cause the processing system to perform any of the methods described in the preceding paragraph.

In another aspect, the disclosure describes a processing system comprising: (1) a memory storing a neural network representing an implicit neural representation of an object; and (2) one or more processors coupled to the memory and configured to: generate, using the neural network, an intersection prediction based on a reference point, a ray, and a perpendicular foot of the ray relative to the reference point, wherein the intersection prediction represents a prediction of whether the ray will intersect with the object; and generate, using the neural network, a distance prediction based on the reference point, the ray, and the perpendicular foot of the ray relative to the reference point, wherein the distance prediction represents a prediction of a shortest distance along the ray between the perpendicular foot and a surface of the object. In some aspects, the one or more processors are configured to generate the intersection prediction and the distance prediction based on the ray where the ray is represented as a ray origin and a ray direction. In some aspects, the one or more processors are configured to generate the intersection prediction and the distance prediction based on the ray where the ray origin is the perpendicular foot of the ray relative to the reference point. In some aspects, the one or more processors are configured to generate the intersection prediction and the distance prediction based on the ray where the ray origin is a point different than the perpendicular foot of the ray relative to the reference point. In some aspects, the one or more processors are further configured to: determine, using the neural network, the perpendicular foot of the ray relative to the reference point. In some aspects, the neural network is configured to determine the perpendicular foot of the ray relative to the reference point based on the ray origin and the ray direction. In some aspects, the neural network is a multilayer perceptron.

In one aspect, the disclosure describes a computer-implemented method of generating an implicit neural representation of an object, comprising: (1) for each given training example of a plurality of training examples, the given training example including a reference point, a ray, a perpendicular foot of the ray relative to the reference point, and a distance indicator indicating a shortest distance along the ray between the perpendicular foot and a surface of the object: generating, using a neural network, a distance prediction based on the reference point, the ray, and the perpendicular foot of the ray relative to the reference point, wherein the distance prediction represents a prediction of the shortest distance along the ray between the perpendicular foot and a surface of the object; and comparing, using one or more processors of a processing system, the distance indicator to the distance prediction to generate a distance loss value for the given training example; and (2) modifying, using the one or more processors, one or more parameters of the neural network based at least in part on the distance loss values generated for the plurality of training examples. In some aspects, for each given training example of the plurality of training examples, the ray is represented as a ray origin and a ray direction. In some aspects, the ray origin is the perpendicular foot of the ray relative to the reference point. In some aspects, the ray origin is a point different than the perpendicular foot of the ray relative to the reference point. In some aspects, the neural network is a multilayer perceptron.

In another aspect, the disclosure describes a computer program product comprising computer readable instructions that, when executed by a processing system, cause the processing system to perform any of the methods described in the preceding paragraph.

In another aspect, the disclosure describes a processing system comprising: (1) a memory storing a neural network; and (2) one or more processors coupled to the memory and configured to generate an implicit neural representation of an object according to a method comprising: (a) for each given training example of a plurality of training examples, the given training example including a reference point, a ray, a perpendicular foot of the ray relative to the reference point, and a distance indicator indicating a shortest distance along the ray between the perpendicular foot and a surface of the object: generating, using a neural network, a distance prediction based on the reference point, the ray, and the perpendicular foot of the ray relative to the reference point, wherein the distance prediction represents a prediction of the shortest distance along the ray between the perpendicular foot and a surface of the object; and comparing, using the one or more processors, the distance indicator to the distance prediction to generate a distance loss value for the given training example; and (b) modifying, using the one or more processors, one or more parameters of the neural network based at least in part on the distance loss values generated for the plurality of training examples. In some aspects, the one or more processors are configured to generate the implicit neural representation of the object according to the method where, for each given training example of the plurality of training examples, the ray is represented as a ray origin and a ray direction. In some aspects, the one or more processors are configured to generate the implicit neural representation of the object according to the method where, for each given training example of the plurality of training examples, the ray origin is the perpendicular foot of the ray relative to the reference point. In some aspects, the one or more processors are configured to generate the implicit neural representation of the object according to the method where, for each given training example of the plurality of training examples, the ray origin is a point different than the perpendicular foot of the ray relative to the reference point. In some aspects, the neural network is a multilayer perceptron.

In one aspect, the disclosure describes a computer-implemented method of generating an implicit neural representation of an object, comprising: (1) for each given training example of a plurality of training examples, the given training example including a reference point, a ray, and a distance indicator indicating a shortest distance along the ray between a perpendicular foot of the ray relative to the reference point and a surface of the object: determining, using a neural network, the perpendicular foot of the ray relative to the reference point; generating, using the neural network, a distance prediction based on the reference point, the ray, and the perpendicular foot of the ray relative to the reference point, wherein the distance prediction represents a prediction of the shortest distance along the ray between the perpendicular foot and a surface of the object; and comparing, using one or more processors of a processing system, the distance indicator to the distance prediction to generate a distance loss value for the given training example; and (2) modifying, using the one or more processors, one or more parameters of the neural network based at least in part on the distance loss values generated for the plurality of training examples. In some aspects, for each given training example of the plurality of training examples, the ray is represented as a ray origin and a ray direction. In some aspects, for each given training example of the plurality of training examples, the neural network determines the perpendicular foot of the ray relative to the reference point based on the ray origin and the ray direction of the given training example. In some aspects, the ray origin is a point different than the perpendicular foot of the ray relative to the reference point. In some aspects, the neural network is a multilayer perceptron.

In another aspect, the disclosure describes a computer program product comprising computer readable instructions that, when executed by a processing system, cause the processing system to perform any of the methods described in the preceding paragraph.

In another aspect, the disclosure describes a processing system comprising: (1) a memory storing a neural network; and (2) one or more processors coupled to the memory and configured to generate an implicit neural representation of an object according to a method comprising: (a) for each given training example of a plurality of training examples, the given training example including a reference point, a ray, and a distance indicator indicating a shortest distance along the ray between a perpendicular foot of the ray relative to the reference point and a surface of the object: determining, using a neural network, the perpendicular foot of the ray relative to the reference point; generating, using the neural network, a distance prediction based on the reference point, the ray, and the perpendicular foot of the ray relative to the reference point, wherein the distance prediction represents a prediction of the shortest distance along the ray between the perpendicular foot and a surface of the object; and comparing, using the one or more processors, the distance indicator to the distance prediction to generate a distance loss value for the given training example; and (b) modifying, using the one or more processors, one or more parameters of the neural network based at least in part on the distance loss values generated for the plurality of training examples. In some aspects, the one or more processors are configured to generate the implicit neural representation of the object according to the method where, for each given training example of the plurality of training examples, the ray is represented as a ray origin and a ray direction. In some aspects, for each given training example of the plurality of training examples, the neural network is configured to determine the perpendicular foot of the ray relative to the reference point based on the ray origin and the ray direction of the given training example. In some aspects, the one or more processors are configured to generate the implicit neural representation of the object according to the method where, for each given training example of the plurality of training examples, the ray origin is a point different than the perpendicular foot of the ray relative to the reference point. In some aspects, the neural network is a multilayer perceptron.

In another aspect, the disclosure describes a computer-implemented method of using a neural network representing an implicit neural representation of an object, comprising: receiving a reference point, a ray, and a perpendicular foot of the ray relative to the reference point; and generating, using the neural network, a distance prediction based on the reference point, the ray, and the perpendicular foot of the ray relative to the reference point, wherein the distance prediction represents a prediction of a shortest distance along the ray between the perpendicular foot and a surface of the object. In some aspects, the ray is represented as a ray origin and a ray direction. In some aspects, the ray origin is the perpendicular foot of the ray relative to the reference point. In some aspects, the ray origin is a point different than the perpendicular foot of the ray relative to the reference point. In some aspects, the method further comprises: determining, using the neural network, the perpendicular foot of the ray relative to the reference point. In some aspects, the neural network is configured to determine the perpendicular foot of the ray relative to the reference point based on the ray origin and the ray direction. In some aspects, the neural network is a multilayer perceptron.

In another aspect, the disclosure describes a computer program product comprising computer readable instructions that, when executed by a processing system, cause the processing system to perform any of the methods described in the preceding paragraph.

In another aspect, the disclosure describes a processing system comprising: (1) a memory storing a neural network representing an implicit neural representation of an object; and (2) one or more processors coupled to the memory and configured to: receive a reference point, a ray, and a perpendicular foot of the ray relative to the reference point; and generate, using the neural network, a distance prediction based on the reference point, the ray, and the perpendicular foot of the ray relative to the reference point, wherein the distance prediction represents a prediction of a shortest distance along the ray between the perpendicular foot and a surface of the object. In some aspects, the one or more processors are configured to generate the distance prediction based on the ray where the ray is represented as a ray origin and a ray direction. In some aspects, the one or more processors are configured to generate the distance prediction based on the ray where the ray origin is the perpendicular foot of the ray relative to the reference point. In some aspects, the one or more processors are configured to generate the distance prediction based on the ray where the ray origin is a point different than the perpendicular foot of the ray relative to the reference point. In some aspects, the one or more processors are further configured to: determine, using the neural network, the perpendicular foot of the ray relative to the reference point. In some aspects, the neural network is configured to determine the perpendicular foot of the ray relative to the reference point based on the ray origin and the ray direction. In some aspects, the neural network is a multilayer perceptron.

### BRIEF DESCRIPTION OF THE DRAWINGS

FIG. 1 is a functional diagram of an example system in accordance with aspects of the disclosure.

FIG. 2 is a functional diagram of an example system in accordance with aspects of the disclosure.

FIG. 3 is a diagram illustrating how rays may be used to generate training examples for use in generating an implicit neural representation of an exemplary object, in accordance with aspects of the disclosure.

FIG. 4 sets forth an exemplary method for training a neural network so as to generate an implicit neural representation of an object, in accordance with aspects of the disclosure.

FIG. 5 sets forth an exemplary method for training a neural network so as to generate an implicit neural representation of an object, in accordance with aspects of the disclosure.

FIG. 6 sets forth an exemplary method for using an implicit neural representation of an object, in accordance with aspects of the disclosure.

FIG. 7 sets forth an exemplary method for training a neural network so as to generate an implicit neural representation of an object, in accordance with aspects of the disclosure.

FIG. 8 sets forth an exemplary method for training a neural network so as to generate an implicit neural representation of an object, in accordance with aspects of the disclosure.

FIG. 9 sets forth an exemplary method for using an implicit neural representation of an object, in accordance with aspects of the disclosure.

### DETAILED DESCRIPTION

The present technology will now be described with respect to the following exemplary systems and methods. Reference numbers in common between the figures depicted and described below are meant to identify the same features.

### Example Systems

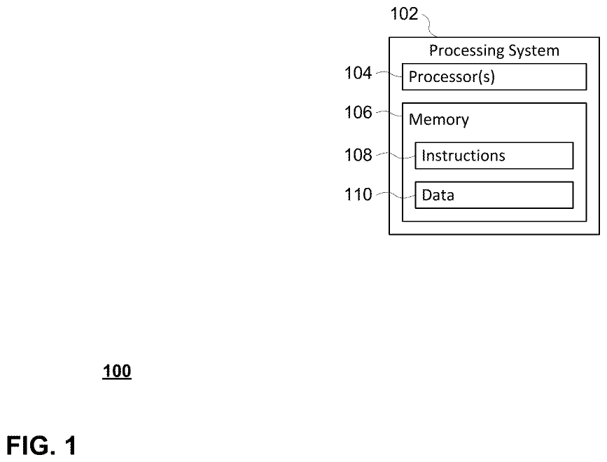

FIG. 1 shows a high-level system diagram 100 of an exemplary processing system 102 for performing the methods described herein. The processing system 102 may include one or more processors 104 and memory 106 storing instructions 108 and data 110. The instructions 108 and data 110 may include a neural network (e.g., a multilayer perceptron), as described further below. In addition, the data 110 may store training examples to be used in training the neural network (e.g., those used to generate an implicit neural representation of an object), training signals and/or loss values generated during such training, and/or values generated by the neural network during training or use.

Processing system 102 may be resident on a single computing device. For example, processing system 102 may be a server, personal computer, or mobile device, and the neural network may thus be local to that single computing device. Similarly, processing system 102 may be resident on a cloud computing system or other distributed system. In such a case, the neural network may be distributed across two or more different physical computing devices. For example, the processing system may comprise a first computing device storing layers 1-n of a neural network having m layers, and a second computing device storing layers n-m of the neural network. In such cases, the first computing device may be one with less memory and/or processing power (e.g., a personal computer, mobile phone, tablet, etc.) compared to that of the second computing device, or vice versa. Likewise, in some aspects of the technology, the processing system may comprise one or more computing devices storing the neural network, and one or more separate computing devices configured to collect and/or generate training examples. Further, in some aspects of the technology, data used by the neural network (e.g., training examples, etc.) may be stored on a different computing device than the neural network.

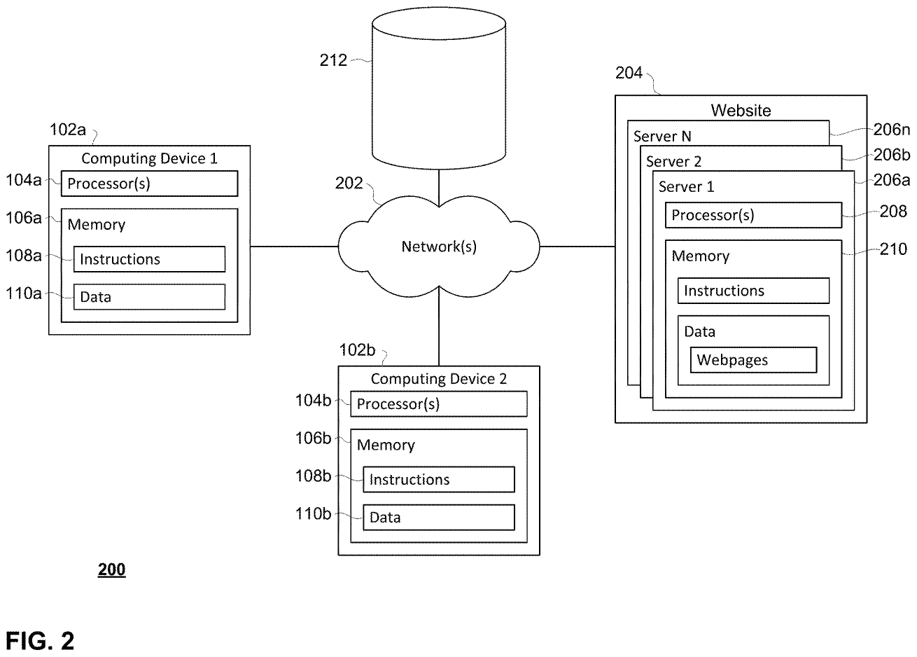

Further in this regard, FIG. 2 shows a high-level system diagram 200 in which the exemplary processing system 102 just described is distributed across two computing devices 102a and 102b, each of which may include one or more processors (104a, 104b) and memory (106a, 106b) storing instructions (108a, 108b) and data (110a, 110b). The processing system 102 comprising computing devices 102a and 102b is shown being in communication with one or more websites and/or remote storage systems over one or more networks 202, including website 204 and remote storage system 212. In this example, website 204 includes one or more servers 206a-206n. Each of the servers 206a-206n may have one or more processors (e.g., 208), and associated memory (e.g., 210) storing instructions and data, including the content of one or more webpages. Likewise, although not shown, remote storage system 212 may also include one or more processors and memory storing instructions and data. In some aspects of the technology, the processing system 102 comprising computing devices 102a and 102b may be configured to retrieve data from one or more of website 204 and/or remote storage system 212, for use in training the neural network. For example, in some aspects, the first computing device 102a may be configured to retrieve training examples from the remote storage system 212 for use in training a neural network housed on the first computing device 102a and/or the second computing device 102b. Likewise, in some aspects, the first computing device 102a may be configured to store the neural network, while the second computing device 102b may be configured to collect data from website 204 to generate training examples based on the retrieved data for use in training the neural network. Further, in such cases, the second computing device 102b may be configured to store one or more of the generated training examples on the remote store system 212, for retrieval by the first computing device 102a.

The processing systems described herein may be implemented on any type of computing device(s), such as any type of general computing device, server, or set thereof, and may further include other components typically present in general purpose computing devices or servers. Likewise, the memory of such processing systems may be of any non-transitory type capable of storing information accessible by the processor(s) of the processing systems. For instance, the memory may include a non-transitory medium such as a hard-drive, memory card, optical disk, solid-state, tape memory, or the like. Computing devices suitable for the roles described herein may include different combinations of the foregoing, whereby different portions of the instructions and data are stored on different types of media.

In all cases, the computing devices described herein may further include any other components normally used in connection with a computing device such as a user interface subsystem. The user interface subsystem may include one or more user inputs (e.g., a mouse, keyboard, stylus, touch screen, and/or microphone) and one or more electronic displays (e.g., a monitor having a screen or any other electrical device that is operable to display information). Output devices besides an electronic display, such as speakers, lights, and vibrating, pulsing, or haptic elements, may also be included in the computing devices described herein.

The one or more processors included in each computing device may be any conventional processors, such as commercially available central processing units (“CPUs”), graphics processing units (“GPUs”), tensor processing units (“TPUs”), etc. Alternatively, the one or more processors may be a dedicated device such as an ASIC or other hardware-based processor. Each processor may have multiple cores that are able to operate in parallel. The processor(s), memory, and other elements of a single computing device may be stored within a single physical housing, or may be distributed between two or more housings. Similarly, the memory of a computing device may include a hard drive or other storage media located in a housing different from that of the processor(s), such as in an external database or networked storage device. Accordingly, references to a processor or computing device will be understood to include references to a collection of processors or computing devices or memories that may or may not operate in parallel, as well as one or more servers of a load-balanced server farm or cloud-based system.

The computing devices described herein may store instructions capable of being executed directly (such as machine code) or indirectly (such as scripts) by the processor(s). The computing devices may also store data, which may be retrieved, stored, or modified by one or more processors in accordance with the instructions. Instructions may be stored as computing device code on a computing device-readable medium. In that regard, the terms “instructions” and “programs” may be used interchangeably herein. Instructions may also be stored in object code format for direct processing by the processor(s), or in any other computing device language including scripts or collections of independent source code modules that are interpreted on demand or compiled in advance. By way of example, the programming language may be C#, C++, JAVA or another computer programming language. Similarly, any components of the instructions or programs may be implemented in a computer scripting language, such as JavaScript, PHP, ASP, or any other computer scripting language. Furthermore, any one of these components may be implemented using a combination of computer programming languages and computer scripting languages.

### Example Methods

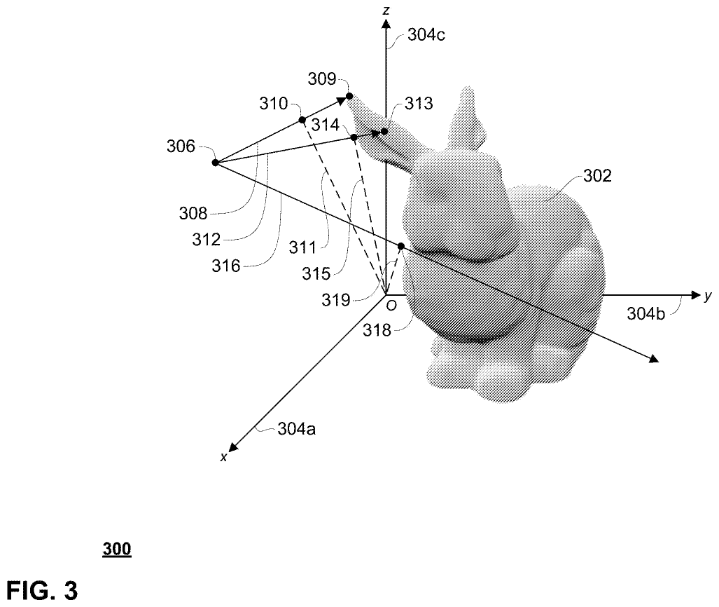

FIG. 3 is a diagram 300 illustrating how rays may be used to generate training examples for use in generating an implicit neural representation of an exemplary object 302, in accordance with aspects of the disclosure. In the example of FIG. 3, the exemplary object 302 is a three-dimensional model of a rabbit, and is shown sitting within a three-axis cartesian coordinate system defined by x axis 304a, y axis 304b, and z axis 304c, each of which meet at an origin O. Diagram 300 further shows three exemplary rays 308, 312, 316, each of which extends in a different direction from a common vantage point 306. As will be understood, the common vantage point 306 used in diagram 300 is only for illustrative purposes. An implicit neural representation may be generated based on training examples which emanate from many different points in space.

In the example of FIG. 3, ray 308 is shown intersecting with the surface of object 302 at point 309, ray 312 is shown intersecting with the surface of object 302 at point 313, and ray 316 is shown passing object 302 without intersecting with its surface. In addition, on each of rays 308, 312, 316, there is an additional point called out which represents that ray's perpendicular foot relative to the origin O of the three-axis cartesian coordinate system. Thus, in the example of FIG. 3, ray 308 has a perpendicular foot relative to origin O at point 310, ray 312 has a perpendicular foot relative to origin O at point 314, and ray 316 has a perpendicular foot relative to origin O at point 318. The perpendicular foot of a given ray relative to origin O is the point at which the given ray is intersected by a plane that is both perpendicular to the given ray and which includes origin O. The perpendicular foot is thus also the point on the given ray that is closest to the origin O, and the point at which a line may run perpendicularly from the given ray to the origin O. These perpendicular lines are depicted in FIG. 3 as dashed lines 311, 315, 319 running from each of rays 308, 312, 316 to the origin O. The perpendicular foot fᵣ of a ray r may be found according to Equation 1 below, where pᵣ represents the origin of the given ray, and dᵣ represents the direction of the given ray.

$${f}_{r} = {d}_{r} \times ( {p}_{r} \times {d}_{r} ) \qquad ( 1 )$$

The ray's origin and direction may be represented in any suitable way. Thus, in some aspects of the technology, the ray origin pᵣ may be a three-element vector representing the cartesian coordinates of a given point on the ray (e.g., point 306 or point 310 of ray 308). Likewise, in some aspects of the technology, the ray direction dᵣ may be a two-element vector representing spherical coordinates indicating the polar angle and azimuth angle of the ray relative to ray origin pᵣ.

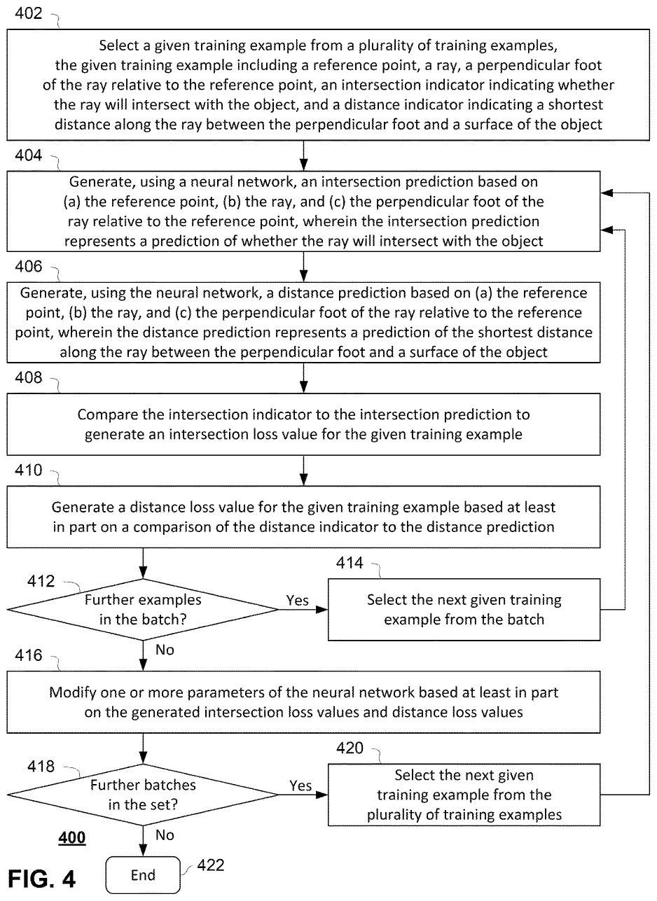

Training examples may be generated from each of rays 308, 312, 316 for use in training a neural network such that it may become an implicit neural representation of object 302. In that regard, in some aspects of the technology, a training example may include a reference point, the ray, the perpendicular foot of the ray relative to the reference point, an intersection indicator indicating whether the ray will intersect with the object, and a distance indicator indicating the shortest distance along the ray between the perpendicular foot and a surface of the object. Thus, using ray 308 as an example, a training example may be generated using the location of origin O as the reference point, a three-element vector representing the cartesian coordinates of point 306 as the ray's origin, a two-element vector representing spherical coordinates indicating ray 308's direction relative to point 306, a three-element vector representing the cartesian coordinates of point 310 as the ray's perpendicular foot, a value of 1 representing the ground truth that ray 308 does intersect with object 302, and a value representing the ground truth of the actual distance between perpendicular foot 310 and point 309. Likewise, for ray 312, a training example may be generated using the location of origin O as the reference point, a three-element vector representing the cartesian coordinates of point 306 as the ray's origin, a two-element vector composed of spherical coordinates representing ray 312's direction relative to point 306, a three-element vector representing the cartesian coordinates of point 314 as the ray's perpendicular foot, a value of 1 representing the ground truth that ray 312 does intersect with object 302, and a value representing the ground truth of the actual distance between perpendicular foot 314 and point 313. In contrast, as ray 316 does not intersect with object 302, a training example may be generated using the location of origin O as the reference point, a three-element vector representing the cartesian coordinates of point 306 as the ray's origin, a two-element vector composed of spherical coordinates representing ray 316's direction relative to point 306, a three-element vector representing the cartesian coordinates of point 318 as the ray's perpendicular foot, a value of 0 representing the ground truth that ray 316 does not intersect with object 302, and a predetermined value (e.g., 0) in place of a distance between perpendicular foot 318 and the surface of object 302. As will be explained further below with respect to method 400 of FIG. 4, a plurality of such training examples may be used to train a neural network such that it becomes capable of efficiently and accurately predicting—based on a reference point, a ray (e.g., ray origin and ray direction), and a perpendicular foot of the ray relative to the reference point—the distance (along the ray) between the ray's perpendicular foot and the nearest surface of the object.

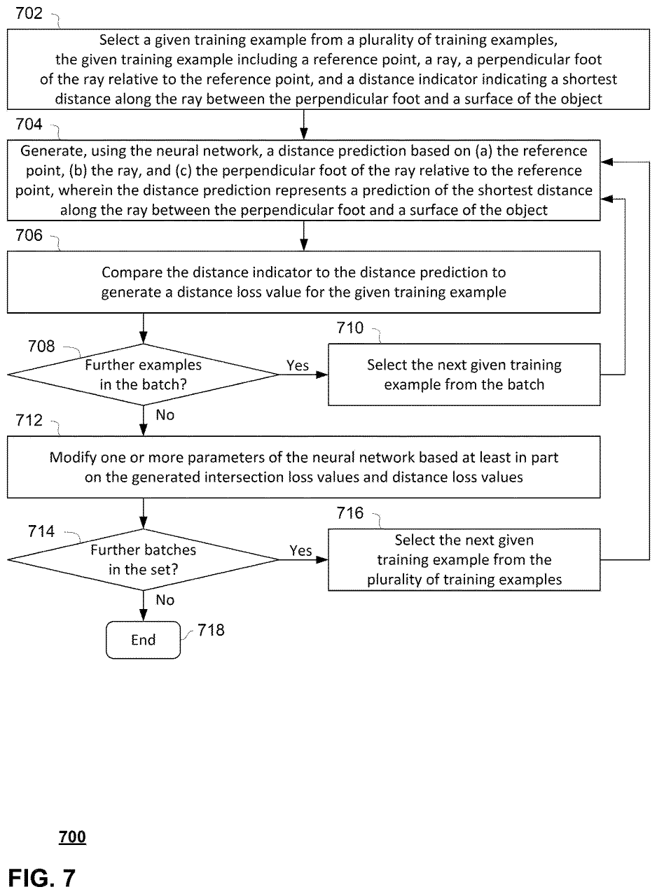

Likewise, in some aspects of the technology, training examples may be generated without including a separate intersection indicator. In that regard, in some aspects of the technology, a training example may include a reference point, the ray, the perpendicular foot of the ray relative to the reference point, and a distance indicator indicating the shortest distance along the ray between the perpendicular foot and a surface of the object. Thus, using ray 308 as an example, a training example may be generated using the location of origin O as the reference point, a three-element vector representing the cartesian coordinates of point 306 as the ray's origin, a two-element vector representing spherical coordinates indicating ray 308's direction relative to point 306, a three-element vector representing the cartesian coordinates of point 310 as the ray's perpendicular foot, and a value representing the ground truth of the actual distance between perpendicular foot 310 and point 309. Likewise, for ray 312, a training example may be generated using the location of origin O as the reference point, a three-element vector representing the cartesian coordinates of point 306 as the ray's origin, a two-element vector composed of spherical coordinates representing ray 312's direction relative to point 306, a three-element vector representing the cartesian coordinates of point 314 as the ray's perpendicular foot, and a value representing the ground truth of the actual distance between perpendicular foot 314 and point 313. In contrast, as ray 316 does not intersect with object 302, a training example may be generated using the location of origin O as the reference point, a three-element vector representing the cartesian coordinates of point 306 as the ray's origin, a two-element vector composed of spherical coordinates representing ray 316's direction relative to point 306, a three-element vector representing the cartesian coordinates of point 318 as the ray's perpendicular foot, and a predetermined value (e.g., −1, 0, 100, etc.) in place of a distance between perpendicular foot 318 and the surface of object 302. As will be explained further below with respect to method 700 of FIG. 7, a plurality of such training examples may be used to train a neural network such that it becomes capable of efficiently and accurately predicting—based on a reference point, a ray (e.g., ray origin and ray direction), and a perpendicular foot of the ray relative to the reference point—the distance (along the ray) between the ray's perpendicular foot and the nearest surface of the object.

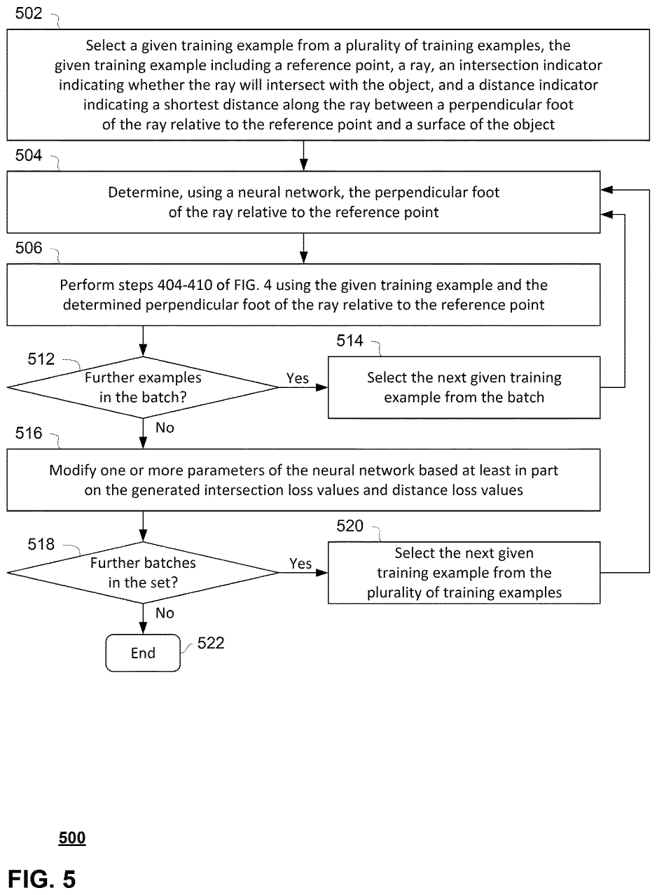

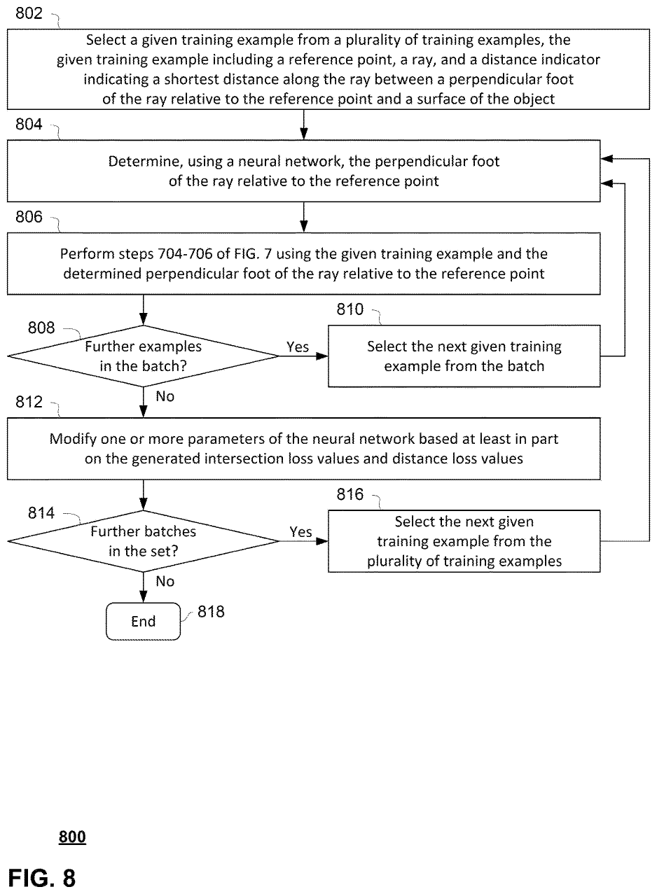

Further, in some aspects of the technology, a neural network may be configured to preprocess each training example in order to automatically generate the perpendicular foot of a ray based on its origin and direction (e.g., using Equation 1, above). In such a case, a training example may include a reference point, the ray, a distance indicator indicating the shortest distance along the ray between the perpendicular foot and a surface of the object (e.g., a ground truth distance value), and, optionally, an intersection indicator indicating whether the ray will intersect with the object (e.g., a ground truth intersection indicator). Thus, using ray 308 as an example, a training example may also be generated using the location of origin O as the reference point, a three-element vector representing the cartesian coordinates of point 306 as the ray's origin, a two-element vector composed of spherical coordinates representing ray 308's direction relative to point 306, a value representing the ground truth of the actual distance between perpendicular foot 310 and point 309, and, optionally, a value of 1 representing the ground truth that ray 308 does intersect with object 302. The neural network may then be configured to use the three-element vector representing the cartesian coordinates of point 306 and the two-element vector composed of spherical coordinates representing ray 308's direction relative to point 306 to generate a three-element vector representing the cartesian coordinates of point 310 as the ray's perpendicular foot. As will be explained further below with respect to method 500 of FIG. 5 and method 800 of FIG. 8, a plurality of such training examples may be used to train a neural network such that it becomes capable of efficiently and accurately predicting—based on a reference point, a ray (e.g., ray origin and ray direction), and a generated perpendicular foot of the ray relative to the reference point—the distance (along the ray) between the ray's perpendicular foot and the nearest surface of the object.

FIG. 4 sets forth an exemplary method 400 for training a neural network so as to generate an implicit neural representation of an object, in accordance with aspects of the disclosure.

In step 402, a processing system (e.g., processing system 102 of FIG. 1 or 2) selects a given training example from a plurality of training examples, the given training example including a reference point, a ray, a perpendicular foot of the ray relative to the reference point, an intersection indicator indicating whether the ray will intersect with the object, and a distance indicator indicating a shortest distance along the ray between the perpendicular foot and a surface of the object.

The reference point may be any suitable point, such as the origin point of a cartesian coordinate system on which the object and the ray may be plotted. Thus, using ray 308 of FIG. 3 as an example, the given training example may include the location of origin O as the reference point.

The ray may be represented in any suitable way. For example, the ray may be represented in terms of its origin and direction, with its origin being a three-element vector representing the cartesian coordinates of a given point on the ray, and with its direction being a two-element vector representing spherical coordinates indicating the polar angle and azimuth angle of the ray relative to the ray's origin. Thus, using ray 308 of FIG. 3 as an example, the given training example may include a three-element vector representing the cartesian coordinates of point 306 as the ray's origin, and a two-element vector representing spherical coordinates indicating ray 308's direction relative to point 306.

As noted above, the perpendicular foot of the ray relative to the reference point is the point at which the ray is intersected by a plane that is both perpendicular to the ray and which includes the reference point. The perpendicular foot is thus also the point on the ray that is closest to the reference point, and the point along the ray at which a line may run perpendicularly from the ray to the reference point. Thus, using ray 308 of FIG. 3 as an example, the given training example may include a three-element vector representing the cartesian coordinates of point 310 as the ray's perpendicular foot relative to reference point O.

The “intersection indicator” indicating whether the ray will intersect with the object may be any suitable value that may be used to signify the ground truth of whether the ray intersects with the object. For example, in some aspects of the technology, the intersection indicator may be set to 1 if the ray will intersect with the object, and may be set to 0 if the ray will not intersect with the object, or vice versa. Thus, using ray 308 of FIG. 3 as an example, the given training example may include a value of 1 representing the ground truth that ray 308 does intersect with object 302. Likewise, using ray 316 of FIG. 3 as another example, the given training example may include a value of 0 representing the ground truth that ray 316 does not intersect with object 302.

The “distance indicator” indicating a shortest distance along the ray between the perpendicular foot and a surface of the object may use any suitable absolute or relative metric. For example, in some aspects of the technology, the distance indicator may indicate a number of units of a cartesian coordinate system on which the object and the ray have been plotted. Likewise, in some aspects of the technology, the distance indicator may be a value based on the number of units of a cartesian coordinate system on which the object and the ray have been plotted, such as a normalized value. Thus, using ray 308 of FIG. 3 as an example, the given training example may include a value representing the ground truth of the number of units (of the cartesian coordinate system) between perpendicular foot 310 and point 309. Likewise, using ray 316 of FIG. 3 as another example, the given training example may include a predetermined value (e.g., 0, 100, etc.) or a predetermined label (e.g., “None”), as ray 316 does not intersect with object 302.

The plurality of training examples may be from any suitable source or collection of sources. For example, the plurality of training examples may be generated by sampling a 3D model of the object from a plurality of different vantage points and directions. The different vantage points may be randomly selected, or selected based on any suitable pattern or other criteria. Likewise, the different directions used from each vantage point may be selected randomly, or based on any suitable criteria.

In step 404, the processing system uses a neural network to generate an intersection prediction based on the reference point, the ray, and the perpendicular foot of the ray relative to the reference point. This intersection prediction represents a prediction of whether the ray will intersect with the object. Here as well, the intersection prediction may be in any suitable range for representing whether the ray intersects with the object. For example, in some aspects of the technology, the neural network may be configured to generate a value between 0 and 1. Likewise, in some aspects, the neural network may be configured to generate a value between 0 and 100. A higher value may indicate a higher likelihood of the ray intersecting with the object, or vice versa.

The processing system may generate the intersection prediction using a neural network of any suitable type, architecture, and number of parameters, including those based on Multilayer Perceptron (“MLP”) architectures, Transformer architectures, Long Short-Term Memory (“LSTM”) architectures, Recurrent Neural Network architectures (“RNN”), Convolutional Neural Network (“CNN”) architectures, and/or any suitable hybrids thereof. For example, in some aspects of the technology, the neural network may be an MLP network having 10 layers with residual connections, with normalization being applied to all layers except the final layer, and with the eight intermediate layers accepting and producing vectors of dimension 512 by 512.

Further, the neural network may generate the intersection prediction based directly or indirectly on the reference point, the ray, and the perpendicular foot of the ray that is included in the given training example. Thus, for example, the processing system or neural network may be configured to initially process the reference point, the ray, and/or the perpendicular foot of the ray to generate modified versions thereof (e.g., normalized versions thereof, versions based on a different coordinate system, vectors based on the reference point, the ray, and/or the perpendicular foot of the ray, etc.). In such cases, the neural network may generate the intersection prediction based on the modified versions of the reference point, the ray, and/or the perpendicular foot of the ray.

In step 406, the processing system uses the neural network to generate a distance prediction based on the reference point, the ray, and the perpendicular foot of the ray relative to the reference point. This distance prediction represents a prediction of the shortest distance along the ray between the perpendicular foot and a surface of the object. Here as well, the neural network may generate the distance prediction based directly or indirectly on the reference point, the ray, and the perpendicular foot of the ray that is included in the given training example. Again, for example, the processing system or neural network may be configured to initially process the reference point, the ray, and/or the perpendicular foot of the ray to generate modified versions thereof (e.g., normalized versions thereof, versions based on a different coordinate system, vectors based on the reference point, the ray, and/or the perpendicular foot of the ray, etc.). In such cases, the neural network may generate the distance prediction based on the modified versions of the reference point, the ray, and/or the perpendicular foot of the ray.

In step 408, the processing system compares the intersection indicator (of the given training example) to the intersection prediction (generated in step 404) to generate an intersection loss value for the given training example. The processing system may make this comparison and generate an intersection loss value in any suitable way, using any suitable loss function(s). For example, in some aspects of the technology, the processing system may be configured to compare the intersection indicator to the intersection prediction using a cross-entropy loss function to generate the intersection loss value. Other classification loss functions may alternatively be used.

In step 410, the processing system generates a distance loss value for the given training example based at least in part on a comparison of the distance indicator (of the given training example) to the distance prediction (generated in step 406). Here as well, the processing system may make this comparison and generate a distance loss value in any suitable way, using any suitable loss function(s). The loss function may be based on the difference between the distance indicator and the distance prediction. For example, in some aspects of the technology, the processing system may be configured to compare the distance indicator to the distance prediction by calculating the absolute value of their difference to generate the distance loss value. Likewise, in some aspects of the technology, the processing system may be configured to compare the distance indicator to the distance prediction by calculating an L1 loss or a p-norm loss to generate the distance loss value.

Further, in some aspects of the technology, the processing system may be configured to automatically set the distance loss value to zero for any training example where the intersection indicator indicates that the ray does not intersect with the object. For example, in some aspects of the technology, the distance loss value may be generated by comparing the distance indicator to the distance prediction as discussed in the preceding paragraph (e.g., using an absolute loss, L1 loss, p-norm loss, etc.), and then multiplying the resulting value by the intersection indicator (e.g., in cases where the intersection indicator is set to be 1 when the ray does intersect the object and 0 when the ray does not intersect the object).

In step 412, the processing system determines if there are further training examples in the batch. In that regard, the plurality of training examples may be broken into multiple batches, or kept whole, in which case there will be one single “batch” containing every training example of the plurality of first training examples. In either case, as shown by the “yes” arrow, if the processing system determines that there are further training examples in the batch, it will proceed to step 414. In step 414, the processing system will select the next given training example from the batch, and then repeat steps 404-412 for that newly selected training example. This process will then be repeated for each next given training example of the batch until the processing system determines, at step 412, that there are no further training examples in the batch, and thus proceeds to step 416 (as shown by the “no” arrow).

As shown in step 416, after an intersection loss value and a distance loss value have been generated (in steps 408 and 410) for every given training example in the batch, the processing system modifies one or more parameters of the neural network based at least in part on the generated intersection loss values and distance loss values. The processing system may be configured to modify the one or more parameters based on these generated loss values in any suitable way and at any suitable interval. For example, an optimization routine, such as stochastic gradient descent, may be applied to the generated loss values to determine parameter modifications. In some aspects of the technology, each “batch” may include a single training example such that the processing system will conduct a back-propagation step in which it modifies the one or more parameters of the neural network every time an intersection loss value and/or a distance loss value is generated. Further in that regard, the processing system may be configured to combine (e.g., add) the intersection loss value and the distance loss value generated for each given training example to generate a single aggregate loss value for the given training example, and to modify the one or more parameters based on that aggregate loss value. Likewise, where each “batch” includes two or more training examples, the processing system may be configured to combine the generated loss values into an aggregate loss value for the batch (e.g., by summing or averaging the multiple loss values), and modify the one or more parameters of the neural network based on that aggregate loss value. In all cases, the processing system may be further configured to ignore or zero-out the distance loss value for any training example for which the intersection indicator indicates that the ray will not intersect with the object.

In step 418, the processing system determines if there are further batches in the plurality of training examples. Where the plurality of training examples has not been broken up, and there is thus one single “batch” containing every training example in the plurality of training examples, the determination in step 418 will automatically be “no,” and method 400 will then end as shown in step 422. However, where the plurality of training examples has been broken into two or more batches, the processing system will follow the “yes” arrow to step 420 to select the next given training example from the plurality of training examples. This will then start another set of passes through steps 404-412 for each training example in the next batch and another modification of one or more parameters of the neural network in step 416. This process will continue until there are no further batches remaining, at which point the processing system will follow the “no” arrow to step 422.

Although method 400 is shown as ending at step 422 once all training examples of the plurality of training examples have been used to tune the parameters of the neural network, it will be understood that method 400 may be repeated any suitable number of times using the same plurality of training examples until each of its predicted intersection and distance predictions are sufficiently close to their respective intersection and distance indicators in each training example. In that regard, in some aspects of the technology, the processing system may be configured to repeat method 400 for the plurality of training examples some predetermined number of times. Further, in some aspects, the processing system may be configured to aggregate all of the loss values generated during a given pass through method 400, and determine whether to repeat method 400 for the plurality of training examples based on that aggregate loss value. For example, in some aspects of the technology, the processing system may be configured to repeat method 400 for the plurality of training examples if the aggregate loss value for the most recent pass through method 400 was greater than some predetermined threshold. Likewise, in some aspects, the processing system may be configured to use gradient descent, and to thus repeat method 400 for the plurality of training examples until the aggregate loss value on a given pass through method 400 is equal to or greater than the aggregate loss value from the pass before it.

FIG. 5 sets forth another exemplary method 500 for training a neural network so as to generate an implicit neural representation of an object, in accordance with aspects of the disclosure. In that regard, FIG. 5 represents a variation on method 400 of FIG. 4, which may be used with a neural network configured to preprocess each training example in order to automatically determine the perpendicular foot of a ray prior to making its predictions.

In step 502, a processing system (e.g., processing system 102 of FIG. 1 or 2) selects a given training example from a plurality of training examples, the given training example including a reference point, a ray, an intersection indicator indicating whether the ray will intersect with the object, and a distance indicator indicating a shortest distance along the ray between a perpendicular foot of the ray relative to the reference point and a surface of the object. The reference point, the ray, the intersection indicator, and the distance indicator may all be as described above with respect to step 402 of FIG. 4.

In step 504, the processing system uses the neural network to determine the perpendicular foot of the ray relative to the reference point. Here as well, the perpendicular foot of the ray relative to the reference point is as described above with respect to step 402 of FIG. 4. The processing system may determine the perpendicular foot in any suitable way. For example, in some aspects of the technology, the ray may be represented in terms of its origin and direction, with its origin being a three-element vector representing the cartesian coordinates of a given point on the ray, and with its direction being a two-element vector representing spherical coordinates indicating the polar angle and azimuth angle of the ray relative to the ray's origin. In such a case, the processing system may be configured to determine the perpendicular foot of the ray based on the ray's origin and direction using Equation 1, above.

In step 506, the processing system performs steps 404-410 of FIG. 4 using the given training example and the determined perpendicular foot of the ray relative to the reference point (determined in step 504). Steps 404-410 may thus be performed in the same manner described above.

In step 512, the processing system determines if there are further training examples in the batch. In that regard, the plurality of training examples may be broken into multiple batches, or kept whole, in which case there will be one single “batch” containing every training example of the plurality of first training examples. In either case, as shown by the “yes” arrow, if the processing system determines that there are further training examples in the batch, it will proceed to step 514. In step 514, the processing system will select the next given training example from the batch, and then repeat steps 504-512 for that newly selected training example. This process will then be repeated for each next given training example of the batch until the processing system determines, at step 512, that there are no further training examples in the batch, and thus proceeds to step 516 (as shown by the “no” arrow).

As shown in step 516, after an intersection loss value and a distance loss value have been generated (in steps 408 and 410) for every given training example in the batch, the processing system modifies one or more parameters of the neural network based at least in part on the generated intersection loss values and distance loss values. The processing system may be configured to modify the one or more parameters based on these generated loss values in any suitable way and at any suitable interval. For example, an optimization routine, such as stochastic gradient descent, may be applied to the generated loss values to determine parameter modifications. In some aspects of the technology, each “batch” may include a single training example such that the processing system will conduct a back-propagation step in which it modifies the one or more parameters of the neural network every time an intersection loss value and/or a distance loss value is generated. Further in that regard, the processing system may be configured to combine (e.g., add) the intersection loss value and the distance loss value generated for each given training example to generate a single aggregate loss value for the given training example, and to modify the one or more parameters based on that aggregate loss value. Likewise, where each “batch” includes two or more training examples, the processing system may be configured to combine the generated loss values into an aggregate loss value for the batch (e.g., by summing or averaging the multiple loss values), and modify the one or more parameters of the neural network based on that aggregate loss value. In all cases, the processing system may be further configured to ignore or zero-out the distance loss value for any training example for which the intersection indicator indicates that the ray will not intersect with the object.

In step 518, the processing system determines if there are further batches in the plurality of training examples. Where the plurality of training examples has not been broken up, and there is thus one single “batch” containing every training example in the plurality of training examples, the determination in step 518 will automatically be “no,” and method 500 will then end as shown in step 522. However, where the plurality of training examples has been broken into two or more batches, the processing system will follow the “yes” arrow to step 520 to select the next given training example from the plurality of training examples. This will then start another set of passes through steps 504-512 for each training example in the next batch and another modification of one or more parameters of the neural network in step 516. This process will continue until there are no further batches remaining, at which point the processing system will follow the “no” arrow to step 522.

Here as well, although method 500 is shown as ending at step 522 once all training examples of the plurality of training examples have been used to tune the parameters of the neural network, it will be understood that method 500 may be repeated any suitable number of times using the same plurality of training examples until each of its predicted intersection and distance predictions are sufficiently close to their respective intersection and distance indicators in each training example. In that regard, in some aspects of the technology, the processing system may be configured to repeat method 500 for the plurality of training examples some predetermined number of times. Further, in some aspects, the processing system may be configured to aggregate all of the loss values generated during a given pass through method 500, and determine whether to repeat method 500 for the plurality of training examples based on that aggregate loss value. For example, in some aspects of the technology, the processing system may be configured to repeat method 500 for the plurality of training examples if the aggregate loss value for the most recent pass through method 500 was greater than some predetermined threshold. Likewise, in some aspects, the processing system may be configured to use gradient descent, and to thus repeat method 500 for the plurality of training examples until the aggregate loss value on a given pass through method 500 is equal to or greater than the aggregate loss value from the pass before it.

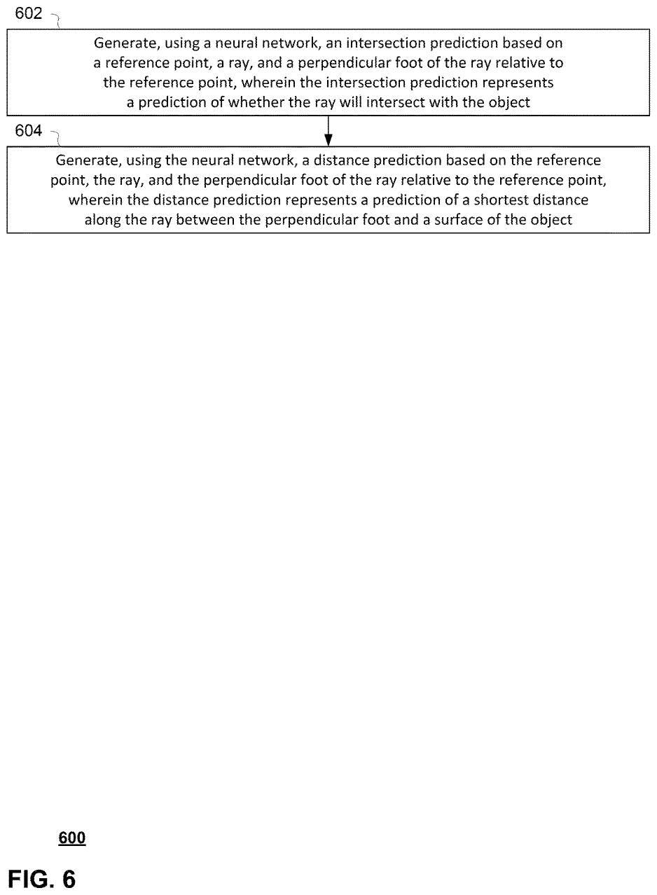

FIG. 6 sets forth an exemplary method 600 for using an implicit neural representation of an object, in accordance with aspects of the disclosure. In that regard, method 600 may be used with an implicit neural representation of an object generated by training a neural network according to method 400 of FIG. 4 or method 500 of FIG. 5.

In step 602, a processing system (e.g., processing system 102 of FIG. 1 or 2) uses a neural network to generate an intersection prediction based on a reference point, a ray, and a perpendicular foot of the ray relative to the reference point. This intersection prediction represents a prediction of whether the ray will intersect with the object.

The reference point, the ray, and the perpendicular foot may all be as described above with respect to step 402 of FIG. 4. In some aspects of the technology, the processing system may be configured to provide the perpendicular foot to the neural network. Likewise, in some aspects of the technology, the neural network may be configured to determine the perpendicular foot of the ray as described above with respect to step 504 of FIG. 5.

As with the intersection prediction of step 404 of FIG. 4, the intersection prediction of step 602 may be a value in any suitable range for representing whether the ray intersects with the object. For example, in some aspects of the technology, the neural network may be configured to generate a value between 0 and 1. Likewise, in some aspects, the neural network may be configured to generate a value between 0 and 100.

Here as well, the processing system may generate the intersection prediction using a neural network of any suitable type, architecture, and number of parameters, including those based on Multilayer Perceptron (“MLP”) architectures, Transformer architectures, Long Short-Term Memory (“LSTM”) architectures, Recurrent Neural Network architectures (“RNN”), Convolutional Neural Network (“CNN”) architectures, and/or any suitable hybrids thereof. For example, in some aspects of the technology, the neural network may be an MLP network having 10 layers with residual connections, with normalization being applied to all layers except the final layer, and with the eight intermediate layers accepting and producing vectors of dimension 512 by 512.

Further, the neural network may generate the intersection prediction based directly or indirectly on the reference point, the ray, and the perpendicular foot of the ray. Thus, for example, the processing system or neural network may be configured to initially process the reference point, the ray, and/or the perpendicular foot of the ray to generate modified versions thereof (e.g., normalized versions thereof, versions based on a different coordinate system, vectors based on the reference point, the ray, and/or the perpendicular foot of the ray, etc.). In such cases, the neural network may generate the intersection prediction based on the modified versions of the reference point, the ray, and/or the perpendicular foot of the ray.

In step 604, the processing system uses the neural network to generate a distance prediction based on the reference point, the ray, and the perpendicular foot of the ray relative to the reference point. This distance prediction represents a prediction of a shortest distance along the ray between the perpendicular foot and a surface of the object. Here as well, the neural network may generate the distance prediction based directly or indirectly on the reference point, the ray, and the perpendicular foot of the ray. Again, for example, the processing system or neural network may be configured to initially process the reference point, the ray, and/or the perpendicular foot of the ray to generate modified versions thereof (e.g., normalized versions thereof, versions based on a different coordinate system, vectors based on the reference point, the ray, and/or the perpendicular foot of the ray, etc.). In such cases, the neural network may generate the distance prediction based on the modified versions of the reference point, the ray, and/or the perpendicular foot of the ray.

In some aspects of the technology, steps 602 and 604 of method 600 may be repeated iteratively over a set of set of rays to “extract” or reconstruct a three-dimensional model of the object encoded by the neural network. For example, a full three-dimensional reconstruction of the surface of the object may be generated by sampling a set of rays from a plurality of ray origins around the object (e.g. from a sphere around the object), and obtaining an intersection and/or distance prediction for each ray.

Likewise, in some aspects of the technology, steps 602 and 604 of method 600 may be repeated iteratively over a set of set of rays to render the object from a given viewpoint. For example, a rendering of the object may be generated by sampling a set of rays that originate from the same point (e.g. a given viewpoint), but which have different ray directions, and obtaining an intersection and/or distance prediction for each ray. In some aspects, the methods described herein may be sufficiently fast for object reconstruction and/or rendering to be performed in real-time, such as may be useful in computer games and/or animations.

Although methods 400, 500, and 600 of FIGS. 4-6 assume that each given training example will include an intersection indicator, and/or that the neural network will be configured to generate an intersection prediction, in some aspects of the technology, the neural network may be trained using training examples that do not include a separate value indicating whether or not the ray will intersect with the object. Exemplary methods for training and using such a neural network are set forth below with respect to FIGS. 7-9.

FIG. 7 sets forth an exemplary method 700 for training a neural network so as to generate an implicit neural representation of an object, in accordance with aspects of the disclosure. In that regard, FIG. 7 represents a variation on method 400 of FIG. 4, which may be used with a neural network configured to generate a distance prediction, but not an intersection prediction.

In step 702, a processing system (e.g., processing system 102 of FIG. 1 or 2) selects a given training example from a plurality of training examples, the given training example including a reference point, a ray, a perpendicular foot of the ray relative to the reference point, and a distance indicator indicating a shortest distance along the ray between the perpendicular foot and a surface of the object. The reference point, the ray, and the distance indicator may all be as described above with respect to step 402 of FIG. 4. However, where the ray does not intersect with the object, the distance indicator may be set to a predetermined value (e.g., −1, 0, 100, etc.).

In step 704, the processing system uses the neural network to generate a distance prediction based on the reference point, the ray, and the perpendicular foot of the ray relative to the reference point. This distance prediction represents a prediction of the shortest distance along the ray between the perpendicular foot and a surface of the object. Here as well, the neural network may generate the distance prediction based directly or indirectly on the reference point, the ray, and the perpendicular foot of the ray that is included in the given training example. Again, for example, the processing system or neural network may be configured to initially process the reference point, the ray, and/or the perpendicular foot of the ray to generate modified versions thereof (e.g., normalized versions thereof, versions based on a different coordinate system, vectors based on the reference point, the ray, and/or the perpendicular foot of the ray, etc.). In such cases, the neural network may generate the distance prediction based on the modified versions of the reference point, the ray, and/or the perpendicular foot of the ray.

Here as well, the processing system may generate the distance prediction using a neural network of any suitable type, architecture, and number of parameters, including those based on Multilayer Perceptron (“MLP”) architectures, Transformer architectures, Long Short-Term Memory (“LSTM”) architectures, Recurrent Neural Network architectures (“RNN”), Convolutional Neural Network (“CNN”) architectures, and/or any suitable hybrids thereof. For example, in some aspects of the technology, the neural network may be an MLP network having 10 layers with residual connections, with normalization being applied to all layers except the final layer, and with the eight intermediate layers accepting and producing vectors of dimension 512 by 512.

In step 706, the processing system compares the distance indicator (of the given training example) to the distance prediction (generated in step 704) to generate a distance loss value. Here as well, the processing system may make this comparison and generate a distance loss value in any suitable way, using any suitable loss function(s). The loss function may be based on the difference between the distance indicator and the distance prediction. For example, in some aspects of the technology, the processing system may be configured to compare the distance indicator to the distance prediction by calculating the absolute value of their difference to generate the distance loss value. Likewise, in some aspects of the technology, the processing system may be configured to compare the distance indicator to the distance prediction by calculating an L1 loss or a p-norm loss to generate the distance loss value.

In step 708, the processing system determines if there are further training examples in the batch. In that regard, the plurality of training examples may be broken into multiple batches, or kept whole, in which case there will be one single “batch” containing every training example of the plurality of first training examples. In either case, as shown by the “yes” arrow, if the processing system determines that there are further training examples in the batch, it will proceed to step 710. In step 710, the processing system will select the next given training example from the batch, and then repeat steps 704-708 for that newly selected training example. This process will then be repeated for each next given training example of the batch until the processing system determines, at step 708, that there are no further training examples in the batch, and thus proceeds to step 712 (as shown by the “no” arrow).

As shown in step 712, after a distance loss value has been generated (in step 704) for every given training example in the batch, the processing system modifies one or more parameters of the neural network based at least in part on the generated distance loss values. The processing system may be configured to modify the one or more parameters based on these generated loss values in any suitable way and at any suitable interval. For example, an optimization routine, such as stochastic gradient descent, may be applied to the generated loss values to determine parameter modifications. In some aspects of the technology, each “batch” may include a single training example such that the processing system will conduct a back-propagation step in which it modifies the one or more parameters of the neural network every time a distance loss value is generated. Likewise, where each “batch” includes two or more training examples, the processing system may be configured to combine the generated distance loss values into an aggregate loss value for the batch (e.g., by summing or averaging the multiple loss values), and modify the one or more parameters of the neural network based on that aggregate loss value.

In step 714, the processing system determines if there are further batches in the plurality of training examples. Where the plurality of training examples has not been broken up, and there is thus one single “batch” containing every training example in the plurality of training examples, the determination in step 714 will automatically be “no,” and method 700 will then end as shown in step 718. However, where the plurality of training examples has been broken into two or more batches, the processing system will follow the “yes” arrow to step 716 to select the next given training example from the plurality of training examples. This will then start another set of passes through steps 704-708 for each training example in the next batch and another modification of one or more parameters of the neural network in step 712. This process will continue until there are no further batches remaining, at which point the processing system will follow the “no” arrow to step 718.

Here as well, although method 700 is shown as ending at step 718 once all training examples of the plurality of training examples have been used to tune the parameters of the neural network, it will be understood that method 700 may be repeated any suitable number of times using the same plurality of training examples until each of its predicted intersection and distance predictions are sufficiently close to their respective intersection and distance indicators in each training example. In that regard, in some aspects of the technology, the processing system may be configured to repeat method 700 for the plurality of training examples some predetermined number of times. Further, in some aspects, the processing system may be configured to aggregate all of the distance loss values generated during a given pass through method 700, and determine whether to repeat method 700 for the plurality of training examples based on that aggregate loss value. For example, in some aspects of the technology, the processing system may be configured to repeat method 700 for the plurality of training examples if the aggregate loss value for the most recent pass through method 700 was greater than some predetermined threshold. Likewise, in some aspects, the processing system may be configured to use gradient descent, and to thus repeat method 700 for the plurality of training examples until the aggregate loss value on a given pass through method 700 is equal to or greater than the aggregate loss value from the pass before it.

FIG. 8 sets forth another exemplary method 800 for training a neural network so as to generate an implicit neural representation of an object, in accordance with aspects of the disclosure. In that regard, FIG. 8 represents a variation on method 700 of FIG. 7, which may be used with a neural network configured to preprocess each training example in order to automatically determine the perpendicular foot of a ray prior to making its predictions.

In step 802, a processing system (e.g., processing system 102 of FIG. 1 or 2) selects a given training example from a plurality of training examples, the given training example including a reference point, a ray, and a distance indicator indicating a shortest distance along the ray between a perpendicular foot of the ray relative to the reference point and a surface of the object. The reference point, the ray, and the distance indicator may all be as described above with respect to step 402 of FIG. 4 and step 702 of FIG. 7.

In step 804, the processing system uses the neural network to determine the perpendicular foot of the ray relative to the reference point. Here as well, the perpendicular foot of the ray relative to the reference point is as described above with respect to step 402 of FIG. 4. The processing system may determine the perpendicular foot in any suitable way. For example, in some aspects of the technology, the ray may be represented in terms of its origin and direction, with its origin being a three-element vector representing the cartesian coordinates of a given point on the ray, and with its direction being a two-element vector representing spherical coordinates indicating the polar angle and azimuth angle of the ray relative to the ray's origin. In such a case, the processing system may be configured to determine the perpendicular foot of the ray based on the ray's origin and direction using Equation 1, above.

In step 806, the processing system performs steps 704-706 of FIG. 7 using the given training example and the determined perpendicular foot of the ray relative to the reference point (determined in step 804). Steps 704-706 may thus be performed in the same manner described above.

In step 808, the processing system determines if there are further training examples in the batch. In that regard, the plurality of training examples may be broken into multiple batches, or kept whole, in which case there will be one single “batch” containing every training example of the plurality of first training examples. In either case, as shown by the “yes” arrow, if the processing system determines that there are further training examples in the batch, it will proceed to step 810. In step 810, the processing system will select the next given training example from the batch, and then repeat steps 804-808 for that newly selected training example. This process will then be repeated for each next given training example of the batch until the processing system determines, at step 808, that there are no further training examples in the batch, and thus proceeds to step 812 (as shown by the “no” arrow).

As shown in step 812, after a distance loss value has been generated (in step 704) for every given training example in the batch, the processing system modifies one or more parameters of the neural network based at least in part on the generated distance loss values. The processing system may be configured to modify the one or more parameters based on these generated loss values in any suitable way and at any suitable interval. For example, an optimization routine, such as stochastic gradient descent, may be applied to the generated loss values to determine parameter modifications. In some aspects of the technology, each “batch” may include a single training example such that the processing system will conduct a back-propagation step in which it modifies the one or more parameters of the neural network every time a distance loss value is generated. Likewise, where each “batch” includes two or more training examples, the processing system may be configured to combine the generated distance loss values into an aggregate loss value for the batch (e.g., by summing or averaging the multiple loss values), and modify the one or more parameters of the neural network based on that aggregate loss value.

In step 814, the processing system determines if there are further batches in the plurality of training examples. Where the plurality of training examples has not been broken up, and there is thus one single “batch” containing every training example in the plurality of training examples, the determination in step 814 will automatically be “no,” and method 800 will then end as shown in step 818. However, where the plurality of training examples has been broken into two or more batches, the processing system will follow the “yes” arrow to step 816 to select the next given training example from the plurality of training examples. This will then start another set of passes through steps 804-808 for each training example in the next batch and another modification of one or more parameters of the neural network in step 812. This process will continue until there are no further batches remaining, at which point the processing system will follow the “no” arrow to step 818.

Here as well, although method 800 is shown as ending at step 818 once all training examples of the plurality of training examples have been used to tune the parameters of the neural network, it will be understood that method 800 may be repeated any suitable number of times using the same plurality of training examples until each of its predicted intersection and distance predictions are sufficiently close to their respective intersection and distance indicators in each training example. In that regard, in some aspects of the technology, the processing system may be configured to repeat method 800 for the plurality of training examples some predetermined number of times. Further, in some aspects, the processing system may be configured to aggregate all of the distance loss values generated during a given pass through method 800, and determine whether to repeat method 800 for the plurality of training examples based on that aggregate loss value. For example, in some aspects of the technology, the processing system may be configured to repeat method 800 for the plurality of training examples if the aggregate loss value for the most recent pass through method 800 was greater than some predetermined threshold. Likewise, in some aspects, the processing system may be configured to use gradient descent, and to thus repeat method 800 for the plurality of training examples until the aggregate loss value on a given pass through method 800 is equal to or greater than the aggregate loss value from the pass before it.

Once a neural network has been trained according to method 700 of FIG. 7 or method 800 of FIG. 8, an application using the resulting implicit neural representation may be configured to ignore distance predictions corresponding to that predetermined value. For example, where the training examples have utilized a predetermined value of 100 for nonintersecting rays, an application using the implicit neural representation to generate a rendering of the object may be configured not to plot any points for which the distance prediction is over a particular threshold (e.g., 99). Likewise, where the training examples have utilized a predetermined value of 0 for nonintersecting rays, an application using the implicit neural representation to generate a rendering of the object may be configured not to plot any points for which the distance prediction is under a particular threshold (e.g., 0.1). Similarly, where the training examples have utilized a predetermined value of −1 for nonintersecting rays, an application using the implicit neural representation to generate a rendering of the object may be configured not to plot any points for which the distance prediction is under a particular threshold (e.g., 0, −0.1, etc.).

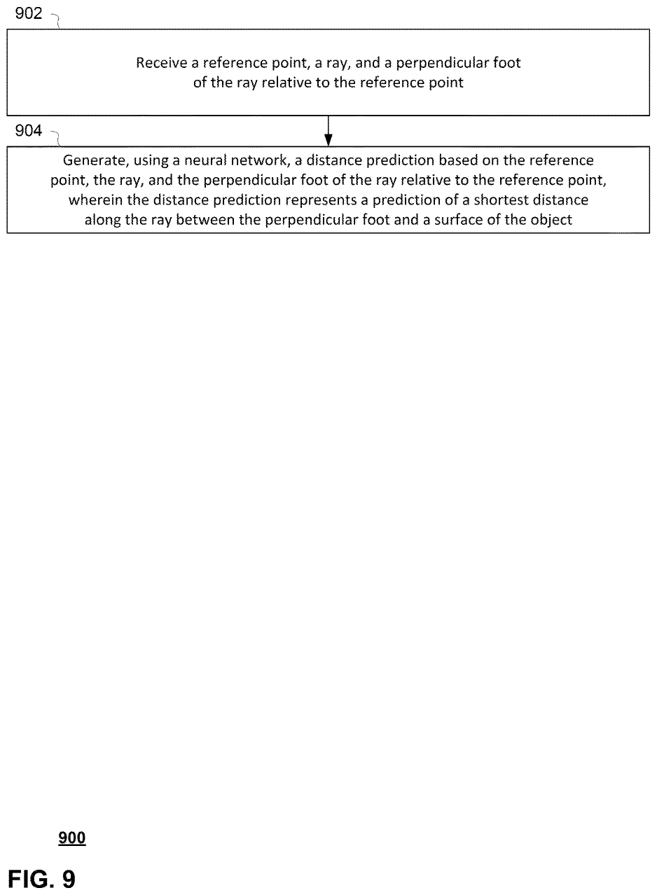

FIG. 9 sets forth an exemplary method 900 for using an implicit neural representation of an object, in accordance with aspects of the disclosure. In that regard, method 900 may be used with an implicit neural representation of an object generated by training a neural network according to method 700 of FIG. 7 or method 800 of FIG. 8.

In step 902, a neural network receives a reference point, a ray, and a perpendicular foot of the ray relative to the reference point. The reference point, the ray, and the perpendicular foot may all be as described above with respect to step 402 of FIG. 4.

In some aspects of the technology, the neural network may receive the perpendicular foot from the processing system. Likewise, in some aspects of the technology, the neural network may be configured to determine the perpendicular foot of the ray as described above with respect to step 804 of FIG. 8, in which case the neural network will receive the perpendicular foot from whatever layer, function, or utility it uses to perform that determination.

In step 904, the processing system uses the neural network to generate a distance prediction based on the reference point, the ray, and the perpendicular foot of the ray relative to the reference point. This distance prediction represents a prediction of a shortest distance along the ray between the perpendicular foot and a surface of the object. Here as well, the neural network may generate the distance prediction based directly or indirectly on the reference point, the ray, and the perpendicular foot of the ray. Again, for example, the processing system or neural network may be configured to initially process the reference point, the ray, and/or the perpendicular foot of the ray to generate modified versions thereof (e.g., normalized versions thereof, versions based on a different coordinate system, vectors based on the reference point, the ray, and/or the perpendicular foot of the ray, etc.). In such cases, the neural network may generate the distance prediction based on the modified versions of the reference point, the ray, and/or the perpendicular foot of the ray.

Here as well, the processing system may generate the distance prediction using a neural network of any suitable type, architecture, and number of parameters, including those based on Multilayer Perceptron (“MLP”) architectures, Transformer architectures, Long Short-Term Memory (“LSTM”) architectures, Recurrent Neural Network architectures (“RNN”), Convolutional Neural Network (“CNN”) architectures, and/or any suitable hybrids thereof. For example, in some aspects of the technology, the neural network may be an MLP network having 10 layers with residual connections, with normalization being applied to all layers except the final layer, and with the eight intermediate layers accepting and producing vectors of dimension 512 by 512.

As with method 600, in some aspects of the technology, steps 902 and 904 of method 900 may be repeated iteratively over a set of set of rays to “extract” or reconstruct a three-dimensional model of the object encoded by the neural network. For example, a full three-dimensional reconstruction of the surface of the object may be generated by sampling a set of rays from a plurality of ray origins around the object (e.g. from a sphere around the object), and obtaining an intersection and/or distance prediction for each ray.

Likewise, in some aspects of the technology, steps 902 and 904 of method 900 may be repeated iteratively over a set of set of rays to render the object from a given viewpoint. For example, a rendering of the object may be generated by sampling a set of rays that originate from the same point (e.g. a given viewpoint), but which have different ray directions, and obtaining an intersection and/or distance prediction for each ray. In some aspects, the methods described herein may be sufficiently fast for object reconstruction and/or rendering to be performed in real-time, such as may be useful in computer games and/or animations.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of exemplary systems and methods should be taken by way of illustration rather than by way of limitation of the subject matter defined by the claims. In addition, the provision of the examples described herein, as well as clauses phrased as “such as,” “including,” “comprising,” and the like, should not be interpreted as limiting the subject matter of the claims to the specific examples; rather, the examples are intended to illustrate only some of the many possible embodiments. Further, the same reference numbers in different drawings can identify the same or similar elements.

1. A computer-implemented method of generating an implicit neural representation of an object, comprising:
for each given training example of a plurality of training examples, the given training example including a reference point, a ray, a perpendicular foot of the ray relative to the reference point, an intersection indicator indicating whether the ray will intersect with the object, and a distance indicator indicating a shortest distance along the ray between the perpendicular foot and a surface of the object:
generating, using a neural network, an intersection prediction based on the reference point, the ray, and the perpendicular foot of the ray relative to the reference point, wherein the intersection prediction represents a prediction of whether the ray will intersect with the object;
generating, using the neural network, a distance prediction based on the reference point, the ray, and the perpendicular foot of the ray relative to the reference point, wherein the distance prediction represents a prediction of the shortest distance along the ray between the perpendicular foot and a surface of the object;
comparing, using one or more processors of a processing system, the intersection indicator to the intersection prediction to generate an intersection loss value for the given training example; and
generating, using the one or more processors, a distance loss value for the given training example based at least in part on a comparison of the distance indicator to the distance prediction; and
modifying, using the one or more processors, one or more parameters of the neural network based at least in part on the intersection loss values and the distance loss values generated for the plurality of training examples.

2. The method of claim 1, wherein, for each given training example of the plurality of training examples, the ray is represented as a ray origin and a ray direction.

3. The method of claim 2, wherein the ray origin is the perpendicular foot of the ray relative to the reference point.

4. The method of claim 2, wherein the ray origin is a point different than the perpendicular foot of the ray relative to the reference point.

5. (canceled)

6. A processing system comprising:
a memory storing a neural network; and
one or more processors coupled to the memory and configured to generate an implicit neural representation of an object according to a method comprising:
for each given training example of a plurality of training examples, the given training example including a reference point, a ray, a perpendicular foot of the ray relative to the reference point, an intersection indicator indicating whether the ray will intersect with the object, and a distance indicator indicating a shortest distance along the ray between the perpendicular foot and a surface of the object:
generating, using a neural network, an intersection prediction based on the reference point, the ray, and the perpendicular foot of the ray relative to the reference point, wherein the intersection prediction represents a prediction of whether the ray will intersect with the object;
generating, using the neural network, a distance prediction based on the reference point, the ray, and the perpendicular foot of the ray relative to the reference point, wherein the distance prediction represents a prediction of the shortest distance along the ray between the perpendicular foot and a surface of the object;
comparing, using one or more processors of a processing system, the intersection indicator to the intersection prediction to generate an intersection loss value for the given training example; and
generating, using the one or more processors, a distance loss value for the given training example based at least in part on a comparison of the distance indicator to the distance prediction; and
modifying, using the one or more processors, one or more parameters of the neural network based at least in part on the intersection loss values and the distance loss values generated for the plurality of training examples.

7. The system of claim 6, wherein the one or more processors are configured to generate the implicit neural representation of the object according to the method where, for each given training example of the plurality of training examples, the ray is represented as a ray origin and a ray direction.

8. The system of claim 7, wherein the one or more processors are configured to generate the implicit neural representation of the object according to the method where, for each given training example of the plurality of training examples, the ray origin is the perpendicular foot of the ray relative to the reference point.

9. The system of claim 7, wherein the one or more processors are configured to generate the implicit neural representation of the object according to the method where, for each given training example of the plurality of training examples, the ray origin is a point different than the perpendicular foot of the ray relative to the reference point.

10. The system of claim 6, wherein the neural network is a multilayer perceptron.

11-20. (canceled)

21. A computer-implemented method of using a neural network representing an implicit neural representation of an object, comprising:
generating, using the neural network, an intersection prediction based on a reference point, a ray, and a perpendicular foot of the ray relative to the reference point, wherein the intersection prediction represents a prediction of whether the ray will intersect with the object; and
generating, using the neural network, a distance prediction based on the reference point, the ray, and the perpendicular foot of the ray relative to the reference point, wherein the distance prediction represents a prediction of a shortest distance along the ray between the perpendicular foot and a surface of the object.

22. The method of claim 21, wherein the ray is represented as a ray origin and a ray direction.

23. The method of claim 22, wherein the ray origin is the perpendicular foot of the ray relative to the reference point.

24. The method of claim 22, wherein the ray origin is a point different than the perpendicular foot of the ray relative to the reference point.

25. The method of claim 22, further comprising:
determining, using the neural network, the perpendicular foot of the ray relative to the reference point.

26. The method of claim 25, wherein the neural network is configured to determine the perpendicular foot of the ray relative to the reference point based on the ray origin and the ray direction.

27. (canceled)

28. A processing system comprising:
a memory storing a neural network representing an implicit neural representation of an object; and
one or more processors coupled to the memory and configured to:
generate, using the neural network, an intersection prediction based on a reference point, a ray, and a perpendicular foot of the ray relative to the reference point, wherein the intersection prediction represents a prediction of whether the ray will intersect with the object; and
generate, using the neural network, a distance prediction based on the reference point, the ray, and the perpendicular foot of the ray relative to the reference point, wherein the distance prediction represents a prediction of a shortest distance along the ray between the perpendicular foot and a surface of the object.

29. The system of claim 28, wherein the one or more processors are configured to generate the intersection prediction and the distance prediction based on the ray where the ray is represented as a ray origin and a ray direction.

30-31. (canceled)

32. The system of claim 29, wherein the one or more processors are further configured to:
determine, using the neural network, the perpendicular foot of the ray relative to the reference point.

33. The system of claim 32, wherein the neural network is configured to determine the perpendicular foot of the ray relative to the reference point based on the ray origin and the ray direction.

34. The system of claim 28, wherein the neural network is a multilayer perceptron.

35-74. (canceled)
